(19) United States
(12) Patent Application Publication
(10) Pub. No.: US 2015/0123766 A1
(43) Pub. Date: May 7, 2015

(54) ESCALATING BIOMETRIC IDENTIFICATION

(71) Applicant: Jerry St. John, Medford Lakes, NJ (US)

(72) Inventor: Jerry St. John, Medford Lakes, NJ (US)

(21) Appl. No.: 14/528,500

(22) Filed: Oct. 30, 2014

Related U.S. Application Data
(60) Provisional application No. 61/898,533, filed on Nov. 1, 2013.

(51) Int. Cl. G07C 9/00; H04L 29/06; H04W 12/06

(52) U.S. Cl. CPC G07C 9/00071; H04W 12/06; H04L 63/0861
USPC 340/5.84; 340/5.82

(57) ABSTRACT

Implementations for enabling escalating biometric identification are described. In one example, the method includes receiving a first biometric identification measurement of a person, comparing the first biometric identification measurement of the person with a stored first biometric identification measurement of the person, determining a first confidence level of a match between the first biometric identification measurement of the person and the stored first biometric identification measurement of the person based on the comparing, and determining whether the first confidence level exceeds a first threshold value.

### RELATED APPLICATIONS

The present application claims the benefit of U.S. Provisional Application Ser. No. 61/898,533, titled “Electronic Monitoring System” filed on Nov. 1, 2013, the entire contents of which are herein incorporated by reference.

### TECHNICAL FIELD

The present disclosure is directed to a method and system for escalating biometric identification, wherein the goal is to track a person's location, and when appropriate, to monitor and evaluate his or her activities. More particularly, the present disclosure is directed to a method and system for escalating biometric identification tests on a smartphone or a client device, with multi-biometric capability and wearable biological signal sensors to enhance the capability monitoring systems.

### BACKGROUND

Electronic monitoring is a known field where an individual's geographic location can be tracked or monitored by a monitoring device. One potential use of electronic monitoring devices is to track the location of people who are incarcerated or under correctional supervision.

It is known that the US prison system is overpopulated with inmates. For example, by the end of 2011 there were slightly over 2.2 million adults imprisoned in U.S. federal or state prisons and county jails, or about 0.7% of the total U.S. adult population. In addition, approximately 4.8 million were on parole or probation. In total approximately 7 million adults, or almost 3% of the U.S. resident population was under correctional supervision.

At the current cost of approximately $80 per day to house an inmate, $60 billion a year is spent to incarcerate offenders. The current budgets for corrections results in enormous pressure to reduce inmate populations.

Electronic monitoring has offered an acceptable alternative to physical incarceration since 1984. It was originally in the form of simple house arrest, using a telephone land line and a radio transceiver beacon. A large bracelet attached at the ankle would electronically communicate with the beacon, which was attached to a telephone land line, to monitor and ensure that the offender was within a certain distance, and therefore “at home”. GPS positioning was later added to the ankle bracelet to bring real time monitoring capability to the device, so that the offender could be tracked as they moved about in their allowed environment.

More recent systems have been introduced that offer voice recognition biometric capability to attempt to identify offenders through telephone communication. These systems typically require that the offender check in at various times from a telephone either at home or work to verify that they are in a predetermined location at the designated time. Several limitations of these systems relate to the fact that they depend on a single biometric and the way they must be used usually uncovers the offender's circumstances, which can hinder the success of the program.

In some cases there is a need to continuously monitor some individuals for alcohol use, if its use is prohibited. In this case, the current systems use a different type of ankle bracelet that measures transdermal alcohol concentrations that, if detected, send alert signals and data samples to a monitoring center where technicians analyze the chemical components of the sample to determine a person's alcohol use. These are completely separate units used for this specific purpose.

Such systems have proven usefulness in reducing incarceration rates, but they rely on a single component, an ankle bracelet, which has shortcomings that create known problems. These problems can have documented detrimental impacts on the program's success. Examples of the more serious shortcomings surrounding the ankle bracelet include the following.

The stigma of the ankle bracelet. Problems with wearing the ankle devices can cause various complications for the offenders being monitored, such as employment obstacles and damage to family relationships, which can dramatically reduce the chances of success for the supervision program. Results from a recent Florida State University study that closely followed approximately 5,000 offenders on Electronic Monitoring, show that “43% claimed that EM is an inconvenience and a burden to their partners and/or negatively impacts their relationships.” “One offender said matter-of-factly that EM ‘serves as a scarlet letter’ and has had a detrimental impact on his relationship with his family.” “Another stated, ‘I've got a child who straps a watch on his ankle to be like Daddy.’ (William Bales, Karen Mann, Thomas Blomberg, Gerry Gaes, Kelle Barrick, Karla Dhungana and Brian McManus, “Quantitative and Qualitative Assessment of Electronic Monitoring” January 2010, final report submitted to NIJ, grant no. 2007-IJ-CX-0017, NCJ 230530.).

When it comes to employment problems the responses are even more alarming. Interview results showed that 61% of offenders said that EM had a negative effect on their ability to find or keep a job. In many cases being employed is a condition of their community release program, and problems like this are adding to the difficulty that the offenders have with succeeding in the program.

Another area of concern is housing. The impact that EM had on an offender's ability to secure housing was significant for approximately 16% of the respondents. Once again, permanent housing is usually a requirement for a community supervision program.

Issues with charging the device. Individuals are required to charge the ankle devices daily, so that there is sufficient power for the next day. A full charge can take up to two hours, while the ankle bracelet that is attached to the offender is connected to a wall outlet. This introduces several problems when the ankle bracelet is being charged while the individual is sleeping, since the power cord to charge the ankle bracelet can inadvertently be unplugged during the night which can result in a partial charge, possibly causing the unit to fail during the next day. As a result, the offender must set aside two hours a day to charge the ankle bracelet.

Problems with GPS signal strength. The fact that the device is worn on the ankle can cause signal loss due to attenuation, which leads to additional tracking problems.

Difficulties involving setup and installation. The device must be properly installed to avoid the chance of injury to the wearer, while at the same time it must be sufficiently secure to avoid tampering. This can take a fair amount of training and skill on the part of the supervising officers.

Thus, there is a need for a system and method configured to overcome the deficiencies of the conventional manner in which offenders who are under supervision in the criminal justice community are electronically monitored.

### SUMMARY

The present disclosure relates to escalating biometric identification for monitoring an individual's geographical location. For example, the monitoring can be a component of a court-ordered supervision program, with respect to offender allowed or disallowed activities and the reporting of the information gathered. Aspects of the present disclosure can also be used to monitor the location of employees or children. Other aspects of the present disclosure can be used by anyone who has a need to monitor the geographic location of any specific person of interest.

When used in conjunction with a court-ordered supervision program, a client device can be used as an alternative tracking device to the traditional “ankle bracelet,” and when applied in this capacity can add improvements over such existing ankle devices. As used herein, a client device may be any device capable of communicating with a server computer via a network. A client device can include, but is not limited to, a smartphone, a computer, a wireless device, a personal digital assistant (e.g., a palmtop computer), a tablet, and/or any suitable computing device. Such devices are suitable platform for monitoring for the following reasons. Client devices are ubiquitous as they are a normal part of everyday lifestyle, and do not appear unusual in any way, offenders can use them as a normal part of their daily activities. In addition, using an offender's existing smartphone and cellular contract can reduce the overall cost of the service.

Client devices have advanced tracking capability as they can be configured with the most current and advanced GPS location technology, and because they are normally held waist high they produce increased signal strength. Better tracking produces fewer alarms and adds to reduced costs.

Client devices have programmable intelligence on the monitoring device that can enhance the system's capability. Some decisions that are currently made at the monitoring center can be pushed out to the device itself, such as notifying an offender that they are approaching an exclusion area or other places that they must avoid under the terms of their program. This decreases the load on the monitoring center and probation officers and provides more efficient operation, and thereby lower cost.

Client devices provide immediate two way communication capability. Being able to communicate with the offender immediately and directly offers a whole realm of additional capabilities. A monitoring center operator can talk to the offender to gather additional information that may clarify issues that could avoid notifying the supervising officer. Better field management reduces the load on the supervising office, once again reducing costs.

Client devices can support a multi-biometric verification without additional hardware. For example, a client device can include three pieces of hardware that allow for biometric verification, a microphone, a camera and a keyboard. Speech, facial recognition and keyboard dynamics biometrics can be used in the field in real time, to positively verify that the offender or specific person of interest is in possession of his or her GPS located smartphone. Multiple biometric modalities are proven to be more accurate than single biometrics, especially in the fluid settings where these devices will be used. Most biometric systems gather input scans in a fixed environment and will be calibrated for that setting. This is not the case for these monitoring devices so single biometric verification can be very unreliable.

The use of client devices, such as smart phones, for electronic monitoring can overcome the stigma associated with current monitoring systems. For example, smartphones are commonplace; they are as common today as a wallet or a purse. Carrying a smartphone is not unusual and it can help the offender overcome the stigma associated with an ankle bracelet. Monitoring activities can appear to be an everyday part of using a smartphone so the offender can function somewhat normally in the community.

A beneficial feature of certain types of client devices that employ cellular smartphone technology is portability, as it can be carried and used by anyone nearly anywhere. However, this trait can also be a drawback to its use as a reliable offender monitoring device. So in order to make the client device a viable alternative to the existing technology, and take advantage of their inherent capabilities, the new system must ensure that the individual being monitored is verifiably linked to his or her client device.

This disclosure supports multiple levels of electronic monitoring that usually coincide with the court ordered parameters of an offender's program.

The first is defined by occasional and random GPS tracking of the offender's client device and verification of the offenders presence using the smartphone's built in input devices for multi-biometric sensing to accomplish, for example, keyboard, voice, and facial verification of the individual. This level can positively track the offender's location at any time.

The second, and more intense monitoring level requires continuous GPS location and biological signal monitoring of the offender by using a wearable device that communicates with the client device. Wearable biological signal devices, in the form of a bracelet, belt or patch, can range from simple heart rate monitors to very advanced devices that can measure ECG, blood pressure, body temperature, brain activity and muscle activity. Data produced from a wearable device can be used to verify the identity of the individual; for example research at the University of Wisconsin has shown that an ECG trace can be used for identification. The results of the research state “In this research, we demonstrated successfully that it is possible to identify a specific person from a group of candidates using a one-lead ECG.” (T. W. Shen, W. J. Tompkins, Y. H. Hu, “One-Lead ECG for Identity Verification,” 2005, Joint Conference of the IEEE Engineering in Medicine and Biology Society and the Biomedical Engineering Society). Biological signal monitoring, used in conjunction with a GPS equipped smartphone, provides a highly secure and superior form of continuous offender electronic monitoring.

The third level is continuous substance use monitoring that may or may not include continuous location monitoring. Continuous biological signal monitoring of the offender or specific person of interest can be employed by using a wearable device that communicates with the client device, and can monitor various data inputs to detect possible alcohol use by the offender or specific person of interest. For example, alcohol has known immediate effects on both heart rate and blood pressure and changes in these biological signals can indicate possible use by the specific person of interest. “Numerous studies have shown a relationship between alcohol intake and elevated clinic blood pressures (BP).” (Ryan J M, Howes L G. “‘White coat’ effect of alcohol” Am J Hypertens 2000; 13:1135-8. Heart. 2002 December; 88(6): 641-642.). And from another study, “ . . . alcohol consumption remained an independent predictor of heart rate.” (Ryan J M, Howes L G, “Relations between alcohol consumption, heart rate, and heart rate variability in men” Heart. 2002 December; 88(6): 641-642). If the signals being monitored become abnormal, the system can respond by administering acuity tests using the specific person of interest's client device, such as a smartphone, as the test device. The ability to utilize the client device, such as a smartphone to receive biological signal input and to immediately administer acuity tests produces a powerful tool for detecting possible alcohol use.

### BRIEF DESCRIPTION OF THE DRAWINGS

The present disclosure will be more readily understood from the detailed description of exemplary embodiments presented below considered in conjunction with the attached drawings, of which:

FIG. 1 depicts a block diagram illustrating an example network architecture in which implementations of the present disclosure can operate.

FIG. 2 illustrates a block diagram of an example escalating biometric identification subsystem in accordance with the present disclosure.

FIG. 3 is a flowchart that diagrams a method of an example escalating biometric identification system in accordance with the present disclosure.

FIG. 4 is a flowchart that diagrams a method of an example escalating biometric identification system in accordance with the present disclosure.

FIG. 5 is a flowchart that diagrams a method of an example escalating biometric identification system in accordance with the present disclosure.

FIG. 6 is a flowchart that diagrams a method of an example escalating biometric identification system in accordance with the present disclosure.

FIG. 7 is an architecture diagram that illustrates the major hardware components that can support the software systems for escalating biometric identification.

FIG. 8 is a block diagram of a computer system that may perform one or more of the operations described herein.

It is to be understood that the attached drawings are for purposes of illustrating the concepts of the disclosure.

### DETAILED DESCRIPTION

The present disclosure provides for methods and systems which allow for the use of biometric and biological signal inputs to be collected from a specific person of interest (e.g., an offender) and communicated with a client device or a smartphone to authenticate that the offender and to confirm that the offender is not engaging in prohibited activity. Biometric inputs are captured on the client device directly from the offender, and biological signal inputs can be captured using a device that can be worn by the offender and communicates with the client device. Aspects of this disclosure enables correctional agencies with the ability to safely use advanced client device technology for electronic monitoring of offenders in community supervision programs, and ensures that the offender is acting within the limits of their program.

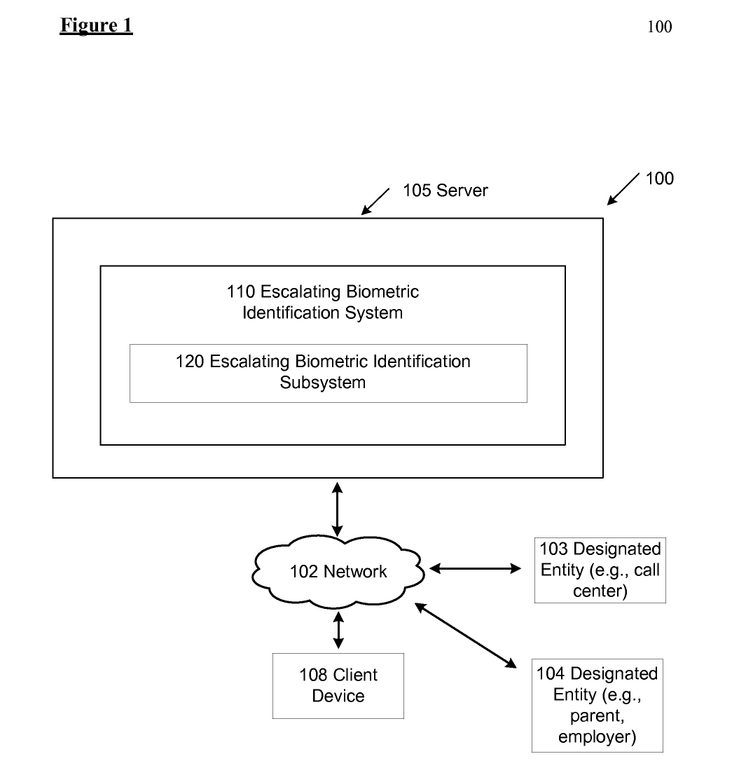

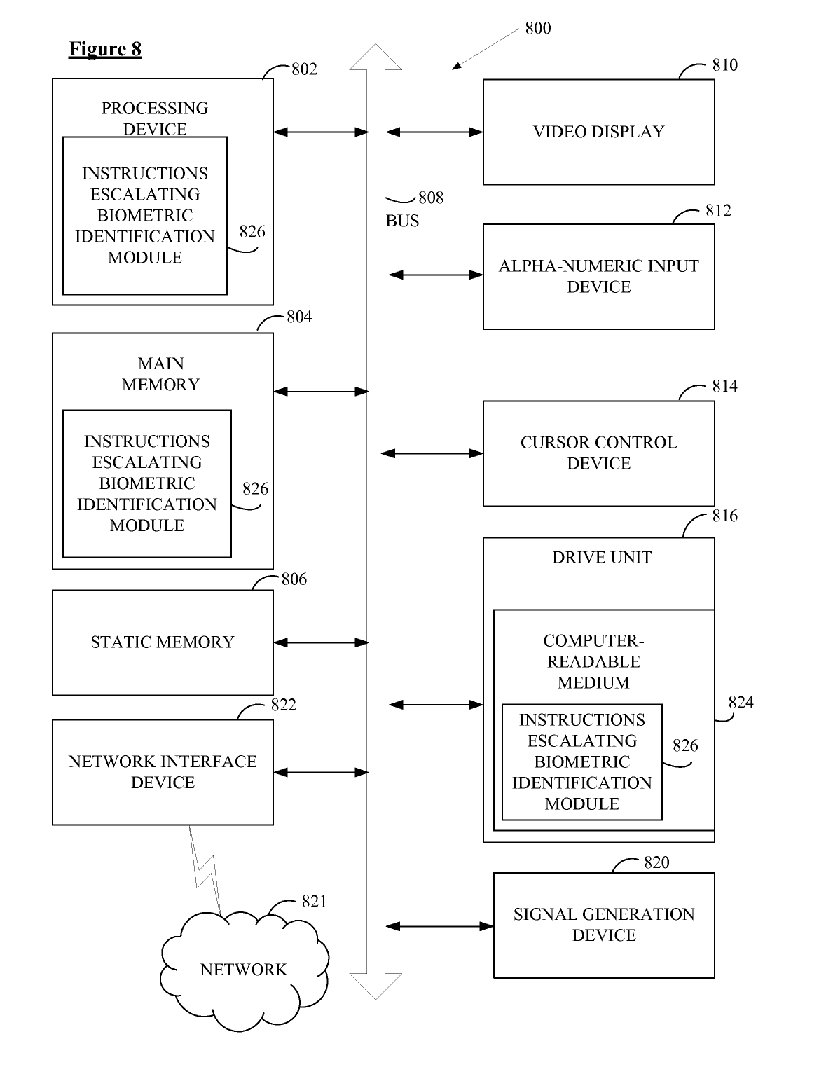

FIG. 1 depicts a block diagram 100 illustrating an example network architecture in which implementations of the present disclosure can operate to provide occasional smartphone or client device monitoring using biometrics for positive identification and authentication. The network architecture 100 may include a server 105, a network 102, designated entities 103 and 104, and a client device 108. The designated entities 103, 104 and the server 105 may each be a computer system to run services that serves the needs of users or other computers on the network 102. An example computer system is described in greater detail below in conjunction with FIG. 8.

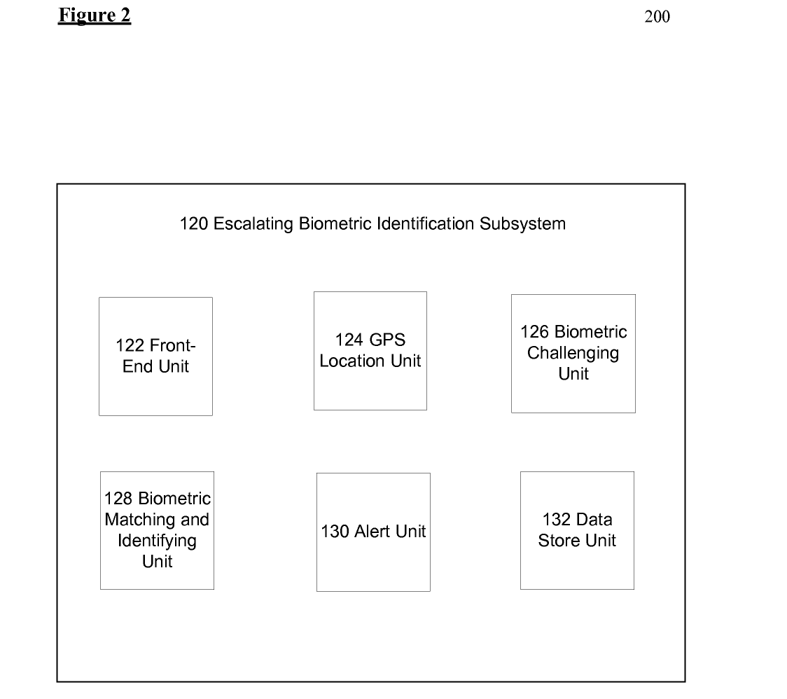

The server 105 includes an escalating biometric identification system 110 for interacting with applications executing on computers associated with the client device 108 and with the designated entities 103, 104 via the network 102. The escalating biometric identification system 110 includes the escalating biometric identification subsystem 120 which is described in further detail below with respect to FIG. 2. In some implementations, the escalating biometric identification system 110 may execute on the client device 108 to execute an escalating biometric identification process or application.

The client device 108 may be any device capable of communicating with the server 105 via the network 102 including, but not limited to, a smartphone, a computer, a wireless device, a personal digital assistant (e.g., a palmtop computer), a tablet, and/or any suitable computing device. In an example, the client device 108 may be a mobile device (e.g., a handheld device, smart phone or web portal device) that communicates with the network 102 via a wireless connection. In an example, the server 105 may determine and verify a user or a specific person of interest that is associated with the client device 108. It is also noted that the term “specific person of interest” is used herein to refer to a person who uses the escalating biometric identification system 110 to verify his or her identity and geographic location. Examples of a specific person of interest include, but are not limited to, an offender, an employee, a child, and any person whose present geographic location is to be verified.

The network 102 may be any type of communications medium that allows for the designated entities 103 and 104 and the client device 108 to communicate with the server 105. The network 102 may be, for example, cellular telephone network, a private network (e.g., a local area network (LAN), a wide area network (WAN), intranet, etc.), a corporate network (e.g., a private network for an organization such as a corporation), and/or a public network (e.g., the Internet). For example, a user or a specific person of interest may use the client device 108 to communicate with the server 105 via the network 102.

FIG. 2 illustrates a block diagram 200 of an example escalating biometric identification subsystem 120 in accordance with the present disclosure. The escalating biometric identification subsystem 120 may include a front-end unit 122, a GPS location unit 124, a biometric challenging unit 126, a biometric matching and identifying unit 128, an alert unit 130, and a data store 132.

The data store unit 132 may be responsible for storing information, such as an association of a specific client device 108 with a specific person of interest and known biometric patterns associated with the specific person of interest. The data store unit 132 may also store biometric test results associated with the specific person of interest for future reference.

The front-end unit 122 may be responsible for receiving a message to initiate a biometric identification session for a specific person of interest (e.g., the offender, the employee, the child, and the like). The message to initiate the biometric identification session may be received from, for example, one or more of the following sources: the client device 108, the designated entity 103, 104 or the server 105. In an embodiment, the biometric identification session may be initiated at intervals that can be determined by the program rules of the specific person of interest.

The front-end unit 122 may instruct the GPS location unit 124 to determine the location of a client device 108 that is associated with the specific person of interest. After the location of a client device 108 that is associated with the specific person of interest is determined, the GPS location unit 124 can determine whether the client device 108 is located in an approved geographic location or is located in a prohibited geographic location. An example of an approved geographic location can include the home or workplace of the specific person of interest, while an example of a prohibited geographic location can include an area away from the home or workplace of the specific person of interest. In an embodiment, the prohibited geographic location can be a bar or a school zone (if, for example, the specific person of interest is prohibited from being in a bar or in a school zone, respectively). In an embodiment, if the client device 108 is located in or is approaching a prohibited geographic location, the alert unit 130 can send a message to a designated entity 103, 104. Example messages include a message that indicates that the client device 108 associated with the specific person of interest is located in or is approaching a prohibited geographic location, or a message that indicates that the client device 108 associated with the specific person of interest is not located in an approved geographic location.

After the location of the client device 108 associated with the specific person of interest is obtained, the biometric challenging unit 126 can initiate testing of the specific person of interest to determine whether he or she is co-located with the associated client device 108. The biometric challenging unit 126 can prompt the specific person of interest, via the network 102 and the client device 108, to take a first biometric identification measurement test.

The results of the first biometric identification measurement test of the specific person of interest are then forwarded to the biometric matching and identifying unit 128, which can attempt to match the results to a known pattern for the specific person of interest. In an embodiment, the biometric matching and identifying unit 128 can determine a confidence level of a match between the result of the first biometric identification measurement test and a record of a known biometric pattern associated with the specific person of interest. If the confidence level exceeds a threshold value, which can indicate that the specific person of interest is identified as the person who responded to the first biometric identification measurement test via the associated client device 108, then the biometric matching and identifying unit 128 can determine that an additional biometric identification measurement test is not necessary. In an embodiment, the alert unit 130 can generate and send a message to the designated entity 103, 104 indicating that the specific person of interest is co-located with the associated client device 108 at the determined geographical location.

In an embodiment, if the confidence level does not exceed the threshold value, which can indicate that the specific person of interest may not be identified as the person who responded to the first biometric identification measurement test via the associated client device 108, the biometric challenging unit 126 can escalate the testing procedure and request that the specific person of interest takes a second biometric identification measurement test. In an embodiment, the first and second biometric identification measurement tests are each in a different modality of biometric identification measurements. As used herein, a “modality” of a biometric identification measurement is a “type” or a “class” of measurement that has distinct characteristics. For example, face recognition, voice recognition, iris recognition, and keyboard dynamics recognition are each different modalities of biometric identification measurement.

Additional examples of different modalities of biometric identification measurement tests can include, but are not limited to, a fingerprint pattern identification, a heart rate identification measurement, an electrocardiogram identification measurement, a blood pressure identification measurement, a body temperature identification measurement, a brain activity identification measurement, a muscle activity identification measurement, a vein pattern identification measurement, and a gait identification measurement.

The results of the second biometric identification measurement test of the specific person of interest are then forwarded to the biometric matching and identifying unit 128, which can attempt to match the second results to a known pattern for the specific person of interest. In an embodiment, the biometric matching and identifying unit 128 can determine a second confidence level of a match between the result of the second biometric identification measurement test and a record of a known biometric pattern associated with the specific person of interest. If the second confidence level exceeds a threshold value, which can indicate that the specific person of interest is identified as the person who responded to the second biometric identification measurement test via the associated client device 108, then the biometric matching and identifying unit 128 can determine that an additional biometric identification measurement test is not necessary. In an embodiment, the alert unit 130 can generate and send a message to the designated entity 103, 104 indicating that the specific person of interest is co-located with the associated client device 108 at the determined geographical location.

In an embodiment, if the second confidence level does not exceed the threshold value, which can indicate that the specific person of interest may not be identified as the person who responded to the first biometric identification measurement test via the associated client device 108, the biometric challenging unit 126 can escalate the testing procedure and request that the specific person of interest takes a third biometric identification measurement test. In an embodiment, the first, second and third biometric identification measurement tests are each in a different modality of biometric identification measurements.

In an embodiment, the results of the third biometric identification measurement test of the specific person of interest are then forwarded to the biometric matching and identifying unit 128, which can attempt to match the third results to a known pattern for the specific person of interest. In an embodiment, the biometric matching and identifying unit 128 can determine a third confidence level of a match between the result of the third biometric identification measurement test and a record of a known biometric pattern associated with the specific person of interest. If the third confidence level exceeds a threshold value, which can indicate that the specific person of interest is identified as the person who responded to the third biometric identification measurement test via the associated client device 108, then the biometric matching and identifying unit 128 can determine that an additional biometric identification measurement test is not necessary. In an embodiment, the alert unit 130 can generate and send a message to the designated entity 103, 104 indicating that the specific person of interest is co-located with the associated client device 108 at the determined geographical location.

In an embodiment, if the third confidence level does not exceed the threshold value, which can indicate that the specific person of interest is not identified as the person who responded to the third biometric identification measurement test via the associated client device 108, then the biometric matching and identifying unit 128 can determine whether to continue with an additional biometric test or to send an alert message to the designated entity 103, 104. In an embodiment, the alert unit 130 can generate and send a message to the designated entity 103, 104 indicating that the specific person of interest is not co-located with the associated client device 108 at the determined geographical location.

The keystroke dynamics identification measurement test can use the keyboard or keypad display of the client device 108. The specific person of interest can be prompted, on the display of the client device 108, to type a challenge phrase that may contain various types of keying combinations. The keystroke dynamics identification measurement test can be based on factors that include, but are not limited to, a keystroke flight time, a keystroke dwell time, a keystroke pressure or a virtual key tracing path. As used herein, the keystroke flight time includes a measurement of the time between keystrokes, the keystroke dwell time includes a measurement of the time that key is pressed, the keystroke pressure includes a measurement of force or pressure for the key that is pressed, and the virtual key tracing path includes a measurement of a pattern of a path that can be created when the specific person of interest slides his or her finger (or slides a stylus) along a keyboard, from the first letter of a word to its last letter, lifting only between words. In an embodiment, the biometric matching and identifying unit 128 can apply context information, such as whether or not the client device 108 and the associated specific person of interest is in motion or stationary, or whether or not the client device 108 is not located at the residence of its associated specific person of interest, in which case the person may be distracted, to determine a pass/fail result. If the biometric matching and identifying unit 128 determines that the identification is sufficient, then the specific person of interest's location and identification score can be recorded by the data store unit 132 for future reference.

The client device 108 can include a microphone that can be used by the voice recognition measurement test. In an embodiment, biometric challenging unit 126 can prompt the specific person of interest to speak a random phrase that can be displayed on the screen of the client device 108. The recorded phrase can be transmitted to a voice recognition match engine algorithm executed by the biometric matching and identifying unit 128 for a dual evaluation, first to determine that the correct words were spoken (voice translation) and second to determine that the voice print generated by the recorded phrase matched the voiceprint on file for the specific person of interest (voice identification). Both tests are needed, since current voice recognition algorithms utilize voiceprint identification technology that can identify a voice irrespective of what is said or in what language, not what was said. To verify that the correct phrase was spoken, voice translation can be used to perform speech to text translation. In an embodiment, the biometric matching and identifying unit 128 can apply context information, such as background noise or quiet location, to determine a pass/fail result. If the biometric matching and identifying unit 128 determines that the identification is sufficient, then the specific person of interest's location and identification score can be recorded by the data store unit 132 for future reference.

The client device 108 can include a camera that can be used in a facial recognition identification measurement test. In an embodiment, the biometric challenging unit 126 can prompt the client device 108 to instruct the specific person of interest to take a photograph of his or her face using the camera of the client device 108. The image can be transmitted to a face recognition program executed by the biometric matching and identifying unit 128 for an evaluation. In an embodiment, the biometric matching and identifying unit 128 can apply context data, image size and brightness, to determine final disposition. If the identification is sufficient, then the specific person of interest's location and identification score can be recorded by the data store unit 132 for future reference.

The threshold values that are associated with the confidence levels can be adjusted based on the environment or surroundings of the client device 108. In an embodiment, the GPS location unit 124 can determine whether the client device 108 is in motion (e.g., in a moving vehicle such as a bus, train, airplane, boat, automobile, etc.) or is stationary. If it is determined that the client device 108 is in motion, then the biometric challenging unit 126 and the biometric matching and identifying unit 128 can adjust the threshold value to compensate for an expected variance in the biometric identification measurement test result due to the fact that the specific person of interest was in motion during the test which likely produces different test results compared to the known test results of the specific person of interest.

Similarly, in an embodiment, the GPS location unit 124 can determine whether the client device 108 is located at the residency or at a known location of the specific person of interest. The known location can be the place of employment or any place that is known to the specific person of interest where he or she may be relaxed and therefore under less stress. If it is determined that the client device 108 is not located at the residency or known location of the specific person of interest, then the biometric challenging unit 126 and the biometric matching and identifying unit 128 can adjust the threshold value to compensate for an expected variance in the biometric identification measurement test result due to the fact that the specific person of interest may be in a location that is not his or her residence, and therefore will likely produce different biometric test results compared to the known test results of the specific person of interest.

Likewise, in an embodiment, the biometric matching and identifying unit 128 can determine whether the client device 108 is located in an environment having a level of light that exceeds a lighting threshold value. If it is determined that the client device 108 is located in an environment having a level of light that does not exceed a lighting threshold value, then the biometric challenging unit 126 and the biometric matching and identifying unit 128 can adjust the threshold value to compensate for an expected variance in the quality of a facial recognition identification measurement test due to inadequate lighting.

Also, in an embodiment, the biometric challenging unit 126 can determine whether a background sound associated with a voice recognition identification measurement test result exceeds a background sound threshold value. If it is determined that the background sound associated with a voice recognition identification measurement test result exceeds a background sound threshold value, then the biometric challenging unit 126 and the biometric matching and identifying unit 128 can adjust the threshold value to compensate for an expected variance in the quality of a voice recognition identification measurement test due to the excessive background noise.

Numerous studies have shown that consumption of alcohol and other drugs affect the chemistry of the brain by altering the level of neurotransmitters, electrical charges in the brain that can be measured. Changes in brain chemistry can increase blood pressure by increasing tension of the muscle tone of the arteries. Similar studies have shown that consumption of alcohol and other drugs affect a person's muscle activity, heart rate, and blood pressure. In an embodiment, a biometric identification measurement of a specific person of interest can include a brain activity identification measurement, a muscle activity identification measurement, an electro cardiogram identification measurement, or a blood pressure identification measurement. The biometric matching and identifying unit 128 can compare such biometric measurement results to the known results of the specific person of interest. In an embodiment, the biometric matching and identifying unit 128 can determine if there are measurable changes in the available biological signals compared to previous samples and if those changes indicate possible alcohol or other prohibited substance use. Based on such comparison, the biometric matching and identifying unit 128 can determine that the person is potentially under an influence of alcohol or drug use. If the results are within an expected range that indicates that the person is not under an influence of alcohol or drug use, then the specific person of interest can be verified and the test data can be stored for future reference.

Responsive to such a determination that the person is potentially under an influence of alcohol or drug use, the biometric challenging unit 126 can send, to the client device 108 associated with the specific person of interest, a message that includes a request for an acuity test or an alcohol breath test of the specific person of interest.

The acuity test can be administered by and taken on the client device 108 and performed by the specific person of interest. Such acuity tests can include keyboard dynamics testing to eliminate someone else being tested in place of the specific person of interest. The acuity tests can also include dexterity and memory tests, similar to a smartphone game. Such tests can measure reaction times and short term memory capacity which could indicate a negative deviation in these abilities from a prior baseline. Examples could include typing a phrase, remembering associated pairs, re-entering a series of numbers that are briefly displayed or repeating a series of colored squares highlighted in a random sequence.

In an embodiment, the alcohol breath test can use a separate testing device for this purpose. The specific person of interest can submit a breath sample into a small handheld device that can determine a blood alcohol concentration (BAC) and can transmit this data to the client device 108 using, for example, a Bluetooth™ connection. A visual recording, using a camera on the client device 108, can provide a positive face matching verification that the breath sample came from the specific person of interest.

In an embodiment, the biometric matching and identifying unit 128 can receive the results of the acuity test or alcohol breath test and determine that the specific person of interest is under an influence of alcohol or drug use based on the test results. Responsive to such a determination, the alert unit 130 can send, to the designated entity 103, 104, a message indicating that the specific person of interest is under the influence of alcohol use or is potentially under the influence of alcohol use.

Aspects of the present disclosure can provide continuous smartphone monitoring and sensing of biological signal data from a device worn by a specific person of interest to provide positive identification and authentication. In an embodiment, the GPS location of the client device 108 can be obtained by the escalating biometric identification system 110. Subsequently, the client device 108 can initiate a protocol, for example Bluetooth or Near Field Communications, to communicate with a biometric sensing device worn by the specific person of interest. In an embodiment, the client device 108 or the escalating biometric identification system 110 can determine whether or not the worn biometric sensing device is active. If communications between the client device 108 and the worn biometric sensing device cannot be established, then the client device 108 can retry to establish communications continuously, at a predetermined interval, until it either successfully establishes communication with the worn device or until a predetermined failure threshold value is reached. If the failure threshold value is reached, the alert unit 130 can send a message to the designated entity indicating that the communications between the client device 108 and the worn biometric sensing device cannot be established.

In an embodiment, if it is determined that the worn biometric sensing device is active, the client device 108 can collect one or more biological signal measurements, for example an ECG. The biological signal measurements, or a data sample of the biological signal measurements, can be transmitted to the escalating biometric identification system 110 that can execute on the server 105, where the biometric matching and identifying unit 128 can attempt to match the ECG tracing submitted with a known trace record for the specific person of interest. In an embodiment, the worn device can include a processing device to operably execute the sampling and matching functions. If a positive match is determined, then the specific person of interest is verified and the biological signal measurements (e.g., ECG trace data) and GPS location data can be stored by the data store unit 132 for future processing. However, if the biometric matching and identifying unit 128 cannot positively verify a match, then the alert unit 130 can generate a message to the designated entity 103, 104 indicating that the match could not be verified.

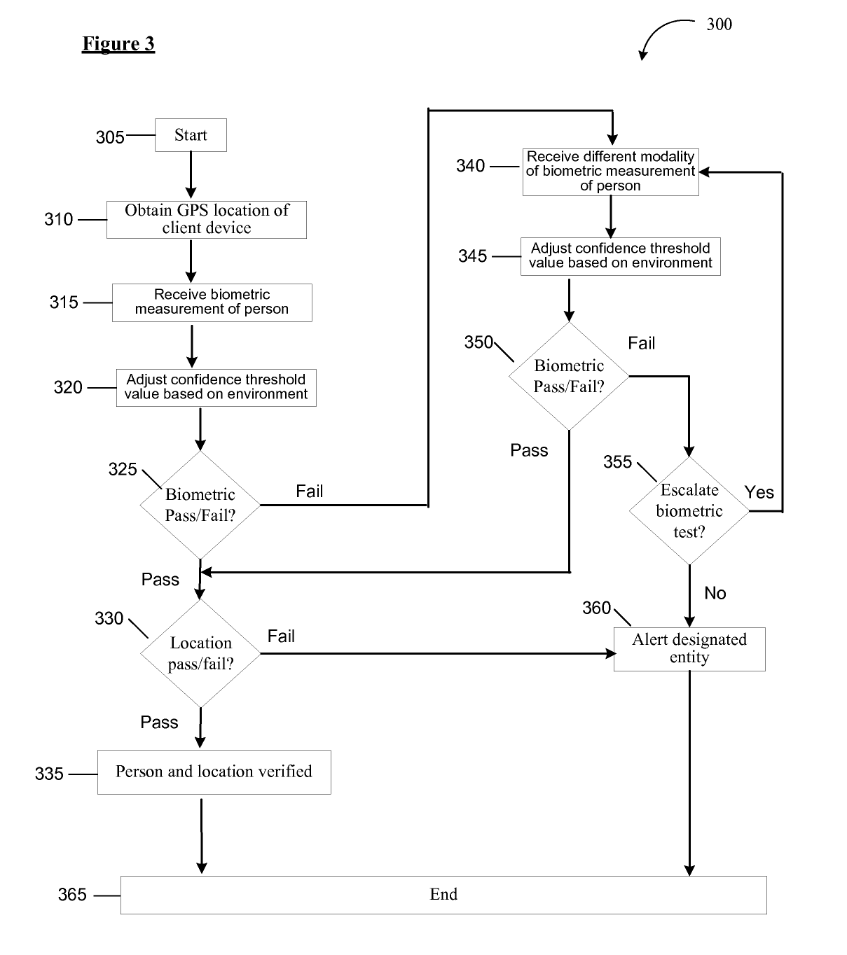

FIG. 3 is a flowchart that diagrams a method of an example escalating biometric identification subsystem in accordance with the present disclosure. The method 300 can be performed by processing logic that may comprise hardware (circuitry, dedicated logic, etc.), software (such may be executed on a general-purpose computing system or a dedicated machine), or a combination of both. At block 305, the method 300 begins. At block 310, the processing logic may obtain the GPS location of the client device 108. At block 315, the processing logic may receive a biometric measurement of a specific person of interest associated with the client device 108. In an embodiment, the biometric measurement can be the result of a keystroke dynamics test, using the smartphone keyboard, where the specific person of interest is prompted, on the smartphone display, to type a challenge phrase that contains various types of keying combinations. At block 320, the processing logic may adjust a confidence threshold based on the environment of the client device 108 to compensate for an expected variance in the biometric identification measurement test result due to the test environment of the specific person of interest (e.g., motion, inadequate lighting, excessive background noise, at a location that is not a residence, and the like).

At block 325, the processing logic may determine whether the specific person of interest is properly identified as the person associated with the client device 108, based on the result of the first biometric identification measurement test. If the biometric test results have passed, then at block 330, the processing logic may determine whether the specific person of interest and his or her associated client device 108 is in an authorized location. If the specific person of interest is in an authorized location, then at block 335, the processing logic may determine that the specific person of interest and the location is verified, and the method ends at block 365.

Reverting to block 325, if the biometric test results have failed, then at block 340, the processing logic may escalate the testing process and receive a different modality of biometric measurement of the specific person of interest associated with the client device 108. In an embodiment, the different biometric measurement can be the result of a voice recognition identification test. At block 345, the processing logic may adjust a confidence threshold based on the environment of the client device 108. At block 350, the processing logic may determine whether the specific person of interest is properly identified as the person associated with the client device 108, based on the result of the different modality of biometric identification measurement test. If the different modality of biometric test results has passed, then at block 330, the processing logic may determine whether the specific person of interest and his or her associated client device 108 is in an authorized location. If the specific person of interest is in an authorized location, then at block 335, the processing logic may determine that the specific person of interest and the location is verified, and the method ends at block 365.

Reverting to block 350, if the different modality of biometric test results has failed, then at block 355, the processing logic may determine whether to escalate the biometric test with another different modality of biometric test that has not been previously used, e.g. a facial recognition identification test. If the processing logic determines to escalate the test with another different modality of biometric test, then at block 340, the method repeats with a different modality of biometric test.

Reverting to block 355, if the processing logic determines not to escalate the test with another different modality of biometric test, then at block 360 the processing logic may alert the designated entity 103, 104 to indicate that the specific person of interest could not be verified and the method ends at block 365.

Reverting to block 330, if the processing logic determines that the specific person of interest and his or her associated client device 108 is not in an authorized location, then at block 360 the processing logic may alert the designated entity 103, 104 to indicate that the specific person of interest could not be verified and the method ends at block 365.

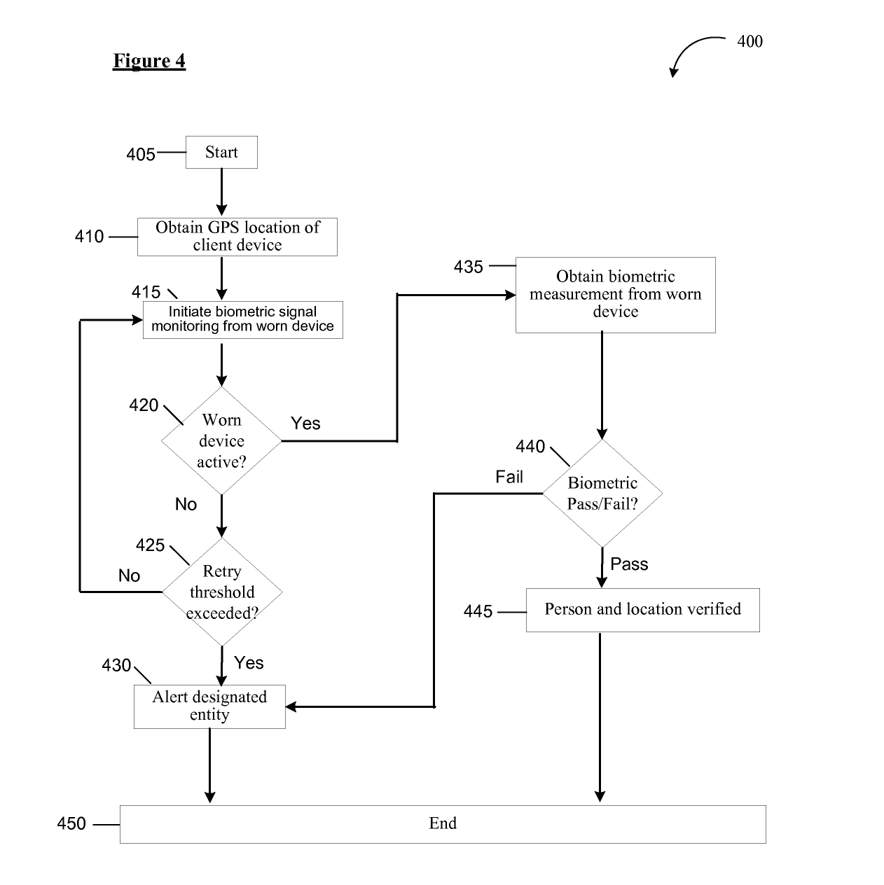

FIG. 4 is a flowchart that diagrams a method of an example escalating biometric identification subsystem in accordance with the present disclosure. The method 400 can be performed by processing logic that may comprise hardware (circuitry, dedicated logic, etc.), software (such may be executed on a general-purpose computing system or a dedicated machine), or a combination of both. At block 405, the method 400 begins. At block 410, a GPS location for the client device 108 associated with a specific person of interest is obtained. At block 415 the client device 108 can initiates a protocol, for example Bluetooth or Near Field Communications, to communicate with a device worn by the specific person of interest (e.g., an offender). At block 420, the method determines if the worn device is active. If communication cannot be established, at block 425 the client device 108 can retry continuously, at a predetermined interval, until it successfully establishes communication with the worn device or until a predetermined failure threshold is reached. If the failure threshold is reached, at block 430 an alert is sent to the designated entity 103, 104 (e.g., a call center), and the method ends at block 450.

Reverting to block 420, if the method determines that the worn device is active, then at block 435 the client device 108 can collect and obtain one or more biological signal measurements, for example an ECG. At block 440 the biological signal measurements, or a data sample of the biological signal measurements are transmitted to the biometric matching and identifying unit 128 that can execute on the server 105 or on the client device 108. The biometric matching and identifying unit 128 can attempt to match the biological signal measurements (e.g., the ECG tracing) submitted with a known trace record for the specific person of interest. If a positive match is determined, at block 445 the specific person of interest is verified and the biological signal measurements (e.g., ECG trace data) and GPS location data can be stored for future processing by the data store unit 132, and the method ends at block 450.

Reverting to block 440, if a trace match cannot be positively verified, then at block 430 the designated entity 103, 104 (e.g., call center) is alerted of the failure of the match and the method ends at block 450.

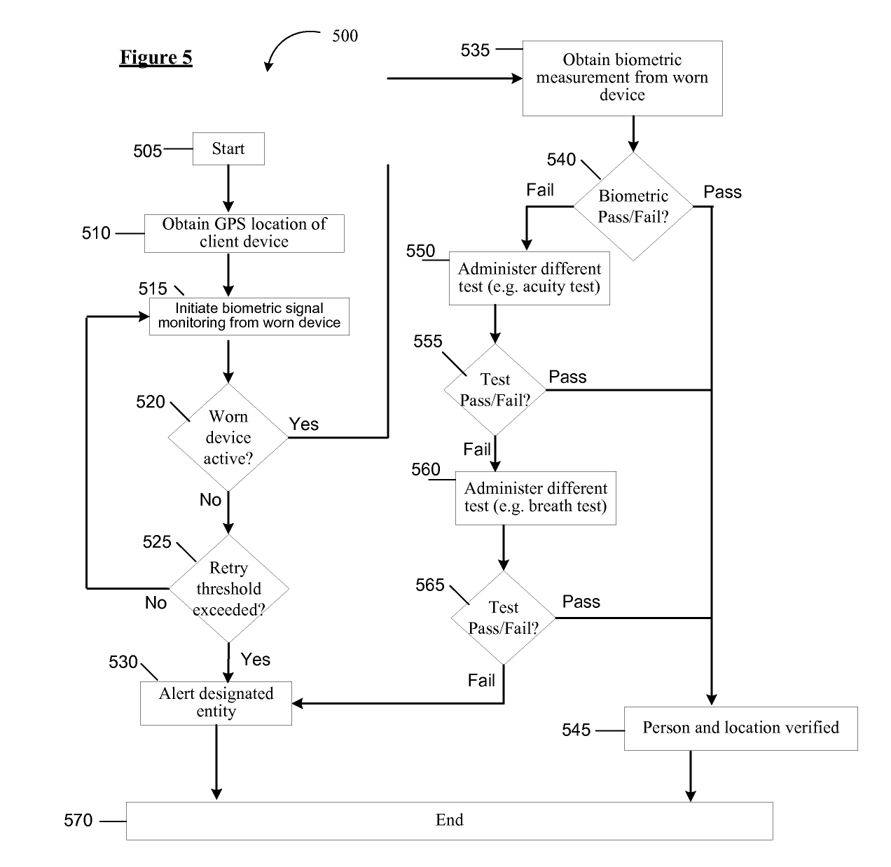

FIG. 5 is a flowchart that diagrams a method of an example escalating biometric identification subsystem in accordance with the present disclosure. The method 500 can be performed by processing logic that may comprise hardware (circuitry, dedicated logic, etc.), software (such may be executed on a general-purpose computing system or a dedicated machine), or a combination of both. At block 505, the method 500 begins. At block 510, a GPS location for the client device 108 associated with a specific person of interest is obtained. At block 515 the client device 108 can initiate a protocol, for example Bluetooth or Near Field Communications, to communicate with a device worn by the specific person of interest (e.g., an offender). At block 520, the method determines if the worn device is active. If communication cannot be established, at block 525 the client device 108 can retry continuously, at a predetermined interval, until it successfully establishes communication with the worn device or until a predetermined failure threshold is reached. If the failure threshold is reached, at block 530 an alert is sent to the designated entity 103, 104 (e.g., a call center), and the method ends at block 570.

Reverting to block 520, if the method determines that the worn device is active, then at block 535 the client device 108 can collect and obtain one or more biological signal measurements, for example an ECG. At block 540 the biological signal measurements, or a data sample of the biological signal measurements are transmitted to the biometric matching and identifying unit 128 that can execute on the server 105 or on the client device 108. The biometric matching and identifying unit 128 can attempt to match the biological signal measurements (e.g., the ECG tracing) submitted with a known trace record for the specific person of interest. If a positive match is determined, at block 545 the specific person of interest is verified and the biological signal measurements (e.g., ECG trace data) and GPS location data can be stored for future processing by the data store unit 132, and the method ends at block 570.

Numerous studies have shown that consumption of alcohol and other drugs affect the chemistry of the brain by altering the level of neurotransmitters, electrical charges in the brain that can be measured. Changes in brain chemistry can increase blood pressure by increasing tension of the muscle tone of the arteries. Reverting to block 540, if there is a variance in the results, then at block 550 a different modality of a test can be administered, e.g., a series of mental acuity tests is initiated. The mental acuity tests can be administered by and taken on the client device 108 (e.g., smartphone) and performed by the specific person of interest (e.g., the offender). These tests can include a facial verification identification test to eliminate someone else being tested in place of the specific person of interest or offender. The acuity tests can also include dexterity and memory tests, similar to a smartphone game. Such tests measure can reaction times and short term memory capacity which could indicate a negative deviation in these abilities from a prior baseline. Examples could include typing a phrase, remembering associated pairs, re-entering a series of numbers that are briefly displayed or repeating a series of colored squares highlighted in a random sequence. In an embodiment, the biometric matching and identifying unit 128 can compare the results of the test (e.g., acuity test) with a known record for the specific person of interest. If a positive match is determined, which can indicate that the specific person if interest is not under the influence of drugs or alcohol, at block 545 the specific person of interest is verified and the test results (e.g., acuity test data) and GPS location data can be stored for future processing by the data store unit 132, and the method ends at block 570.

At block 555, if a positive match is not determined based on the comparison of the results of the test (e.g., acuity test) with the known record for the specific person of interest, which can indicate that the specific person if interest might be under the influence of drugs or alcohol, then at block 560, a different modality of a test can be administered (e.g., a breath test to determine the blood alcohol content). At block 565, if the test results indicate that the specific person of interest is not under the influence of drugs or alcohol, then at block 545 the specific person of interest is verified and the test results (e.g., breath test) and GPS location data can be stored for future processing by the data store unit 132, and the method ends at block 570. At block 565, if the test results indicate that the specific person of interest is under the influence of drugs or alcohol, then at block 530 an alert is sent to the designated entity 103, 104 (e.g., a call center), and the method ends at block 570.

If the combination of biological signal data and acuity testing indicates the possible use of a banned substance, alcohol for example, then at block 560 a breath test can be initiated. The breath test can use a separate testing device for this purpose. The specific person of interest (e.g., the offender) can submit a breath sample into a small handheld device that determines a blood alcohol concentration (BAC) and transmits this data to the client device 108 (e.g., smartphone) using, for example, a Bluetooth™ connection. A visual recording, using the smartphone camera, can provide positive face matching verification that the breath sample came from the specific person of interest (e.g., the offender). In an embodiment, the mental acuity test results and the BAC test results are assembled and stored by the data store unit 132. At block 530, the test results can be transmitted to the designated entity 103, 104 (e.g., call center) via an alert message indicating the failure of the match and/or a report of a possible infraction, and the method ends at block 570.

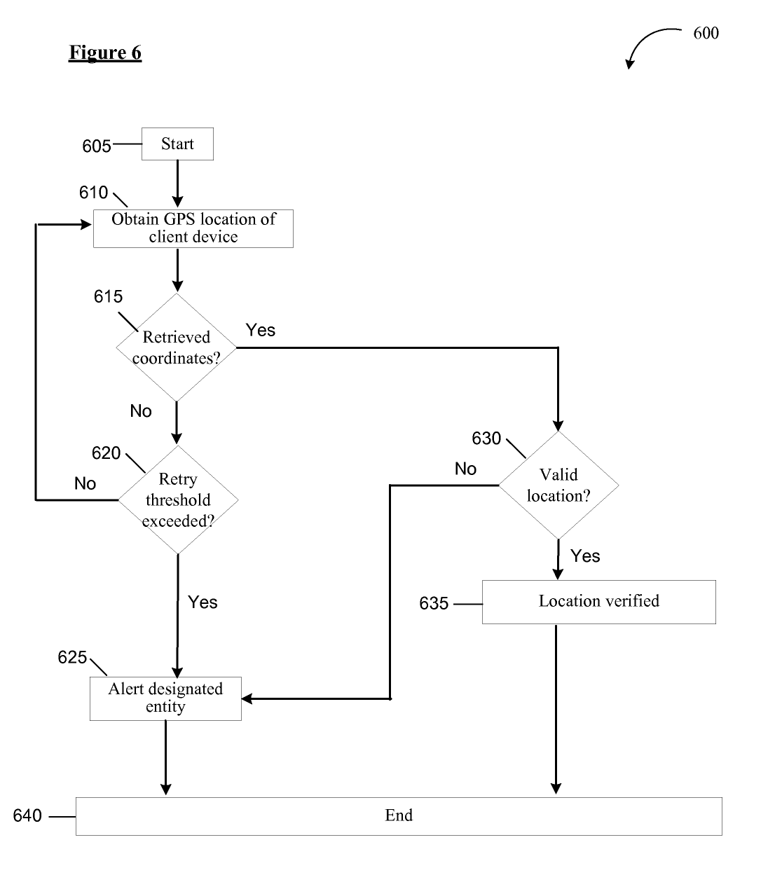

FIG. 6 is a flowchart that diagrams a method of an example escalating biometric identification subsystem in accordance with the present disclosure. The method 600 can be performed by processing logic that may comprise hardware (circuitry, dedicated logic, etc.), software (such may be executed on a general-purpose computing system or a dedicated machine), or a combination of both. At block 605, the method 600 begins. At block 610, GPS location monitoring can be run either occasionally or continually depending on the type of location monitoring required for the program, whereby an application executing on the client device 108 (e.g., smartphone) can acquire the GPS coordinates from the client device 108. At block 615, if a GPS fix cannot be established, then at block 620 the processing logic can retry continuously, at a predetermined interval, until it successfully retrieves the location coordinates or until a predetermined failure threshold value is reached. If at block 620 the failure threshold value is reached, then at block 625 the processing logic can send an alert to the designated entity 103, 104 (e.g., call center). In an embodiment, the processing logic and use a cellular communication protocol, and the method ends at block 640.

Reverting to block 610, if the GPS coordinates have been successfully retrieved, then at block 630 the processing logic can retrieve the coordinates and transmit them to the GPS location unit 124 that can be running on server 105. The coordinates can be forwarded using, e.g., a cellular communication protocol. The processing logic can analyze the GPS location to determine that they are within the limits of the rules of movement for the specific person of interest (e.g., the offender), for example they are where they should be (e.g., home, work, school, etc.) or they are approaching or are in an excluded area (e.g., a rival gang area, a school zone, etc.). At block 630, if there is any deviation from the valid location of the specific person of interest, the processing logic can send an alert to the designated entity 103, 104 (e.g., call center) with appropriate data, and at block 640 the method ends.

Reverting to block 630, if the location of the GPS coordinates is valid, then at block 635 the location is verified, the GPS coordinates of the verified location can be stored by the data store unit 132 for access by other processes, and the method ends at block 640.

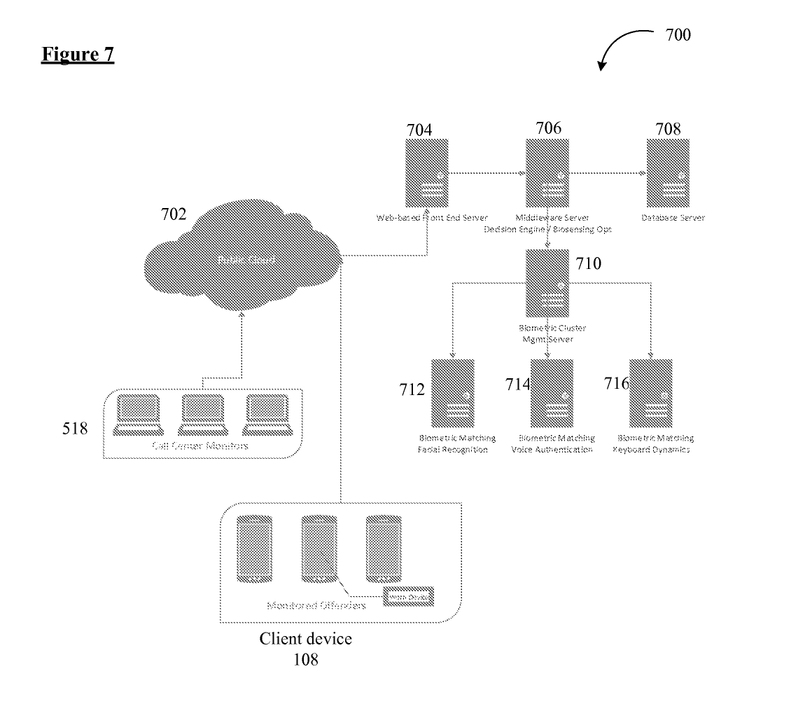

FIG. 7 is an architecture diagram that illustrates the major hardware components that can support the software systems for escalating biometric identification. The monitored specific person of interest (e.g., the offender's) client device 108 can run the remote applications needed to provide the appropriate level of monitoring for the offender's program. They can provide the application interfaces that interact with the offender to gather and distribute the event transaction data. Some client devices 108 can interact with devices worn by the specific person of interest (e.g., the offender) that can gather biological signal information needed by the client device 108 to accomplish the monitoring task. Client devices 108 can communicate via the public cloud 702 or via cellular communications protocol with a web-based front end server 704 that can host the web applications and web services. The web-based front end server 704 can support the various user interfaces and the two way transaction traffic for the system. The middleware server 706 can execute the applications that support decision making processes that are generated by the system. This server can process incoming transactions for biometric matching or biological signal analysis. System record and transaction data can be managed by a database server 708. Biometric match requests can be forwarded to a biometric cluster server 710 that can manage the submission of the data and the return of the match results. Match requests can be submitted to the appropriate match node for facial recognition 712, voice authentication 714 or keyboard dynamics template matching 716. Call center operators 718 can interact with the system and the offenders via the public cloud 702 thru browser applications and VoIP, to provide monitoring support of alerts generated by the client device 108 smartphone or the decision engines.

FIG. 8 illustrates a diagrammatic representation of a machine in the form of a computer system, in accordance with one example. The computing system may include a set of instructions 826, for causing the machine to perform any one or more of the methodologies discussed herein. In alternative examples, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while a single machine is illustrated, the term “machine” shall also be taken to include any collection of machines (e.g., computers) that individually or jointly execute a set (or multiple sets) of instructions to perform any one or more of the methodologies discussed herein.

The computer system 800 includes a processing device 802, a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory 816 (e.g., a data storage device), which communicate with each other via a bus 830.

The processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute the operations for private point-to-point communication between computing devices for performing steps discussed herein.

The computer system 800 may further include a network interface device 822. The network interface device may be in communication with a network 821. The computer system 800 also may include a video display unit 810 (e.g., a liquid crystal display (LCD), a touch screen, or a cathode ray tube (CRT)), an alphanumeric input device 812 (e.g., a keyboard), a cursor control device 814 (e.g., a mouse), and a signal generation device 820 (e.g., a speaker).

The secondary memory 816 may include a computer-readable storage medium (or more specifically a non-transitory computer-readable storage medium) 824 on which is stored one or more sets of instructions 826 (e.g., instructions executed by computing devices for escalating biometric identification testing) for the computer system 800 representing any one or more of the methodologies or functions described herein. The instructions 826 for the computer system 800 may also reside, completely or at least partially, within the main memory 804 and/or within the processing device 802 during execution thereof by the computer system 800, the main memory 804 and the processing device 802 also constituting computer-readable storage media. The instructions 826 for the computer system 800 may further be transmitted or received over a network via the network interface device 822.

While the computer-readable storage medium 824 is shown in an example to be a single medium, the term “computer-readable storage medium” should be taken to include a single medium or multiple media (e.g., a centralized or distributed database, and/or associated caches and servers) that store the one or more sets of instructions 826. The term “computer-readable storage medium” shall also be taken to include any medium that is capable of storing or encoding a set of instructions for execution by the machine that cause the machine to perform any one or more of the methodologies of the disclosure. The term “computer-readable storage medium” shall accordingly be taken to include, but not be limited to, solid-state memories, and optical and magnetic media.

Some portions of the detailed descriptions above are presented in terms of symbolic representations of operations on data bits within a computer memory. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “configuring,” “associating,” “executing,” “adjusting,” “sending,” “receiving,” “determining,” “transmitting,” “identifying,” “specifying,” “granting,” “accessing,” “assigning,” “detecting,” and “requesting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The descriptions and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the disclosure is not described with reference to any particular programming language. It will be appreciated that a variety of programming languages may be used to implement the teachings of the disclosure as described herein.

It is to be understood that the above description is intended to be illustrative, and not restrictive. Many other examples will be apparent to those of skill in the art upon reading and understanding the above description. Although the disclosure has been described with reference to specific examples, it will be recognized that the disclosure is not limited to the examples described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
receiving, by a processing device, a first biometric identification measurement of a person;
comparing, by the processing device, the first biometric identification measurement of the person with a stored first biometric identification measurement of the person;
determining, by the processing device, a first confidence level of a match between the first biometric identification measurement of the person and the stored first biometric identification measurement of the person based on the comparing;
determining, by the processing device, whether the first confidence level exceeds a first threshold value;
in response to determining that the first confidence level does not exceed the first threshold value:
sending, by the processing device, to a device associated with the person, a message comprising a request for a second biometric identification measurement of the person, wherein the first biometric identification measurement of the person and the second biometric identification measurement of the person are each in a different modality of biometric identification measurements;
receiving, by the processing device, the second biometric identification measurement of the person;
comparing, by the processing device, the second biometric identification measurement of the person with a stored second biometric identification measurement of the person; and
determining, by the processing device, a second confidence level of a match between the second biometric identification measurement of the person and the stored second biometric identification measurement of the person.

2. The method of claim 1, wherein the first biometric identification measurement of the person is one of a keystroke dynamics identification measurement, a voice recognition identification measurement, a facial recognition identification measurement, a fingerprint pattern identification, a heart rate identification measurement, an electro cardiogram identification measurement, a blood pressure identification measurement, a body temperature identification measurement, a brain activity identification measurement, a muscle activity identification measurement, an iris identification measurement, a vein pattern identification measurement, or a gait identification measurement.

3. The method of claim 2, wherein the keystroke dynamics identification measurement is based on at least one of a keystroke flight time, a keystroke dwell time, a keystroke pressure or a virtual key tracing path.

4. The method of claim 3, wherein the first biometric identification measurement of the person comprises a keystroke dynamics identification measurement, further comprising:
determining, by the processing device, whether a device associated with the person is in motion or is stationary;
in response to determining that the device associated with the person is in motion:
lowering the first threshold value; and
determining, by the processing device, whether the first confidence level exceeds the first threshold value based on the lowered first threshold value.

5. The method of claim 3, wherein the first biometric identification measurement of the person comprises a keystroke dynamics identification measurement, further comprising:
determining, by the processing device, whether a device associated with the person is located at a known location of the person;
in response to determining that the device associated with the person is not located at the residency of the person:
lowering the first threshold value; and
determining, by the processing device, whether the first confidence level exceeds the first threshold value based on the lowered first threshold value.

6. The method of claim 1, wherein the first biometric identification measurement of the person comprises a facial recognition identification measurement of the person, further comprising:
determining, by the processing device, whether the device associated with the person is located in an environment having a level of light that does not exceed a lighting threshold value;
in response to determining that the device associated with the person is located in an environment having a level of light that does not exceed the lighting threshold value:
lowering the first threshold value; and
determining, by the processing device, whether the first confidence level exceeds the first threshold value based on the lowered first threshold value.

7. The method of claim 1, wherein the first biometric identification measurement of the person comprises a voice recognition identification measurement of the person, further comprising:
determining, by the processing device, whether a background sound associated with the voice recognition identification measurement of the person exceeds a background sound threshold value;
in response to determining that the background sound associated with the voice recognition identification measurement of the person exceeds the background sound threshold value:
lowering the first threshold value; and
determining, by the processing device, whether the first confidence level exceeds the first threshold value based on the lowered first threshold value.

8. The method of claim 1, wherein the first biometric identification measurement of the person comprises one of a brain activity identification measurement, a muscle activity identification measurement, an electro cardiogram identification measurement, or a blood pressure identification measurement, further comprising:
determining, by the processing device, that the person is potentially under an influence of at least one of alcohol or drug use based on the comparing;
sending, by the processing device, to a device associated with the person, a message comprising a request for at least one of an acuity test or an alcohol breath test of the person;
receiving, by the processing device, at least one of an acuity test result or an alcohol breath test result of the person;
determining, by the processing device, that the person is under an influence of alcohol or drug use based on the at least one of the acuity test or the alcohol breath test result of the person; and
sending, by the processing device, to a designated entity, a message comprising an indication that the person is under the influence of alcohol use or is potentially under the influence of alcohol use.

9. The method of claim 1, further comprising:
determining, by the processing device, that a location of the device associated with the person is different than an expected location of the person; and
in response to determining that the location of the device associated with the person is different than an expected location of the device:
sending, by the processing device, to a designated entity, a message comprising an indication that the person is not located in the expected location of the person.

10. The method of claim 1, further comprising:
determining, by the processing device, that a location of the device associated with the person is approaching or is located in a prohibited area; and
in response to the determining, by the processing device, that the location of the device associated with the person is approaching a prohibited area:
sending, by the processing device, to a designated entity or to the device associated with the person, a message comprising an indication that the person is approaching or is located in a prohibited area.

11. The method of claim 1, further comprising:
determining, by the processing device, whether the second confidence level exceeds a second threshold value;
in response to determining that the second confidence level does not exceed the second threshold value:
sending, by the processing device, to the device associated with the person, a message comprising a request for a third biometric identification measurement of the person, wherein the first biometric identification measurement of the person, the second biometric identification measurement of the person, and the third biometric identification measurement of the person are each in a different modality of biometric identification measurements;
receiving, by the processing device, the third biometric identification measurement of the person;
comparing, by the processing device, the third biometric identification measurement of the person with a stored third biometric identification measurement of the person;
determining, by the processing device, a third confidence level of a match between the third biometric identification measurement of the person and the stored third biometric identification measurement of the person;
determining, by the processing device, whether the third confidence level exceeds a third threshold value;
in response to a determination that the third confidence level does not exceed the third threshold value:
sending, by the processing device, to a designated entity, a message comprising an indication that the device associated with the person is not located in close proximity to the person.

12. A system comprising:
a memory device; and
a processing device, operatively coupled to the memory device, the processing device to:
receive a first biometric identification measurement of a person;
compare the first biometric identification measurement of the person with a stored first biometric identification measurement of the person;
determine a first confidence level of a match between the first biometric identification measurement of the person and the stored first biometric identification measurement of the person based on the comparing;
determine whether the first confidence level exceeds a first threshold value;
in response to a determination that the first confidence level does not exceed the first threshold value:
send, to a device associated with the person, a message comprising a request for a second biometric identification measurement of the person, wherein the first biometric identification measurement of the person and the second biometric identification measurement of the person are each in a different modality of biometric identification measurements;
receive the second biometric identification measurement of the person;
compare the second biometric identification measurement of the person with a stored second biometric identification measurement of the person; and
determine a second confidence level of a match between the second biometric identification measurement of the person and the stored second biometric identification measurement of the person.

13. The system of claim 12, wherein the first biometric identification measurement of the person is one of a keystroke dynamics identification measurement, a voice recognition identification measurement, a facial recognition identification measurement, a fingerprint pattern identification, a heart rate identification measurement, an electro cardiogram identification measurement, a blood pressure identification measurement, a body temperature identification measurement, a brain activity identification measurement, a muscle activity identification measurement, an iris identification measurement, a vein pattern identification measurement, or a gait identification measurement.

14. The system of claim 13, wherein the keystroke dynamics identification measurement is based on at least one of a keystroke flight time, a keystroke dwell time, a keystroke pressure or a virtual key tracing path.

15. The system of claim 14, wherein the first biometric identification measurement of the person comprises a keystroke dynamics identification measurement, further comprising:
determine whether a device associated with the person is in motion or is stationary;
in response to a determination that the device associated with the person is in motion:
lower the first threshold value; and
determine whether the first confidence level exceeds the first threshold value based on the lowered first threshold value.

16. The system of claim 14, wherein the first biometric identification measurement of the person comprises a keystroke dynamics identification measurement, further comprising:
determine whether a device associated with the person is located at a residency of the person;
in response to a determination that the device associated with the person is not located at the residency of the person:
lower the first threshold value; and
determine whether the first confidence level exceeds the first threshold value based on the lowered first threshold value.

17. A non-transitory machine-readable storage medium including instructions that, when accessed by a processing device, cause the processing device to perform operations comprising:
receiving, by a processing device, a first biometric identification measurement of a person;
comparing, by the processing device, the first biometric identification measurement of the person with a stored first biometric identification measurement of the person;
determining, by the processing device, a first confidence level of a match between the first biometric identification measurement of the person and the stored first biometric identification measurement of the person based on the comparing;
determining, by the processing device, whether the first confidence level exceeds a first threshold value;
in response to determining that the first confidence level does not exceed the first threshold value:
sending, by the processing device, to a device associated with the person, a message comprising a request for a second biometric identification measurement of the person, wherein the first biometric identification measurement of the person and the second biometric identification measurement of the person are each in a different modality of biometric identification measurements;
receiving, by the processing device, the second biometric identification measurement of the person;
comparing, by the processing device, the second biometric identification measurement of the person with a stored second biometric identification measurement of the person; and
determining, by the processing device, a second confidence level of a match between the second biometric identification measurement of the person and the stored second biometric identification measurement of the person.

18. The non-transitory machine-readable storage medium of claim 17, wherein the first biometric identification measurement of the person is one of a keystroke dynamics identification measurement, a voice recognition identification measurement, a facial recognition identification measurement, a fingerprint pattern identification, a heart rate identification measurement, an electro cardiogram identification measurement, a blood pressure identification measurement, a body temperature identification measurement, a brain activity identification measurement, a muscle activity identification measurement, an iris identification measurement, a vein pattern identification measurement, or a gait identification measurement.

19. The non-transitory machine-readable storage medium of claim 18, wherein the keystroke dynamics identification measurement is based on at least one of a keystroke flight time, a keystroke dwell time, a keystroke pressure or a virtual key tracing path.

20. The non-transitory machine-readable storage medium of claim 19, wherein the first biometric identification measurement of the person comprises a keystroke dynamics identification measurement, further comprising:
determining, by the processing device, whether a device associated with the person is in motion or is stationary;
in response to determining that the device associated with the person is in motion:
lowering the first threshold value; and
determining, by the processing device, whether the first confidence level exceeds the first threshold value based on the lowered first threshold value.
